(19) United States
(12) Patent Application Publication
(10) Pub. No.: US 2017/0144401 A1
(43) Pub. Date: May 25, 2017

(54) DEVICE FOR ASSEMBLING CARDBOARD BOXES

(71) Applicant: BOIX MAQUINARIA, S.L., San Isidro de Albatera (Alicante) (ES)

(72) Inventor: José BOIX JAEN, San Isidro de Albatera (Alicante) (ES)

(21) Appl. No.: 14/967,844

(22) Filed: Dec. 14, 2015

(30) Foreign Application Priority Data
Nov. 20, 2015 (ES) U201531291

(51) Int. Cl. B31B 1/46

(52) U.S. Cl. CPC B31B 1/46; B31B 2201/2666; B31B 2203/066

(57) ABSTRACT

It is a device that can assemble cardboard boxes from a die cut sheet with a rectangular bottom, chamfered vertical corners at 45° and opposing bridges arranged in correspondence with the mouth of the box and which run from the edges of two of the opposing parallel walls of the box, so that the device that is the object of the invention features a series of mechanisms that speed up and improve the process of forming and assembling the box, and can also give shape to corners angled at 45° located on the convergence of the ends of the lateral walls, where said corners of the box comprise several superimposed corner sections.

### OBJECT OF THE INVENTION

The present invention, as expressed in the title of this description, refers to a device for assembling cardboard boxes aimed at forming and assembling cardboard boxes from a die cut sheet after having applied previously adhesive material on strategic areas of some of the parts of said die cut cardboard sheet.

From this premise, the object of the invention is a device that allows the forming of cardboard boxes with a rectangular bottom, chamfered vertical corners at 45°, and opposing bridges arranged in correspondence with the mouth of the box, which start on the edges of two of the opposing parallel walls of the box, so that the device object of the invention incorporates a series of mechanisms that speed up and improve the process of forming and assembling the box.

### TECHNICAL PROBLEM TO BE SOLVED AND BACKGROUND OF THE INVENTION

Currently there are known moulds for assembling cardboard boxes, such as the moulds corresponding to the patents with publication numbers ES 2179739 and ES 2189680 in Spain.

Invention patent with application number P 201331712 in Spain is also known, which consists in a mould to form and assemble cardboard boxes, and comprises fixing means strategically distributed in devices located on the corners of the mould where equipment selected between a series of additional alternative and exchangeable devices and assemblies can be attached and supported by said devices located on the corners, and where said equipment corresponds to the different respective models of boxes.

Likewise, invention patent with application number P 200102719 in Spain is known, which consists in a mould to form and assemble cardboard boxes aimed at forming boxes with rectangular bottoms and, significantly, with opposing bridges arranged on a horizontal plane in correspondence with the mouth of said box, and where said bridges start from the edges of two of the opposing parallel walls of the box.

In all these cases, each boxes is assembled from a die cut sheet set facing a hole in the mould, so that it is then inserted into said hole by means of a male element pushing it down. During this process when the male element descends, the box is assembled and then the different devices come into action in order to complete the process of assembling the box, which is finally pushed out from the lower part of the mould.

All of the moulds described above have the limitation that they are not able to form boxes with chamfered vertical corners at 45°.

### DESCRIPTION OF THE INVENTION

The device for assembling cardboard boxes comprises a mould and a male element that pushes the die cut sheet towards a central space of the mould, where a box with a rectangular bottom with chamfered corners at 45° after is assembled, having previously applied an adhesive material on the sheet.

Said mould comprises four modular structures and two additional opposing structures, each of them supporting different mechanisms that take part in assembling the box, where said four modular structures and the two additional opposing structures define the central space where the die cut cardboard sheet used to assembly each box is inserted into.

The modular structures are coupled by pairs on two parallel guide frames; the two additional opposing structures are located in correspondence with the two opposing walls where said guide frames are located; the box comprising two side walls and two front walls that converge on corners angled at 45°, made up first by first corner sections that run from the ends of the side walls, by second corner sections that run from the ends of the front walls, and by inner sections that are part of extensions that run from the ends of the two bridges running from the edges of the side walls; and said extensions of the bridges also comprise outer sections that lean against the front walls;

The modular structures comprise at least the following:

Vertical folding elements set facing each other by pairs, which have two angled breaks that make up first upper inclined sections, second vertical sections, and third inclined sections longer than the first sections; where cylinder-shaped vertical extensions are attached to the lower ends of the vertical folding elements, and said vertical folding elements are secured to transverse bars.

Folding cylinders attached to said transverse bars by means of heads attached in turn to folding washers integrally joined to angled bodies screwed to the transverse bars; where said folding cylinders comprise rods with spherical lugs that work on some parts of the die cut sheets during the descent of the male element.

Elevation mechanisms to lift and lower angled stops during the process of assembling the box; where said angled stops make contact with the parts of the box that correspond to the ends of the front walls.

Corner stops that press against the corners of the box during the assembling process, where said corner stops rotate around vertical axes and where said stops are supported by the angled stops.

The modular structures also comprise opposing mechanisms to make up the bridges by folding them, and tabs with angled cuts attached to assembling parts of the modular structures by means of regulating elements that control the vertical position of said tabs.

The elevation mechanism comprises pairs of upper and lower tilting handles that rotate around axes attached to angled supports, where said tilting handles are articulately connected by means of another pair of axes with solid pieces integrally joined to the angled stops.

The upper tilting handles comprise radial extensions where the rods of vertical cylinders rotate around, said vertical cylinders rotate around lower axes attached to front supports joined to the angled supports.

The corner stops rotate around the vertical axes by means of horizontal cylinders, which are articulately connected to outer pieces attached to end supports, the end supports comprising horizontal branches where said outer pieces are attached and vertical branches comprising pairs of hinged parts supplementary to other pairs of hinged parts attached to the corner stops.

Said horizontal cylinders comprise rods connected to end heads where the vertical axes on which the corner stops rotate are attached.

Under the opposing mechanisms holding mechanisms are located, the holding mechanisms comprising flat bearing surfaces where the rectangular bottom of the box and vertical rollers rest on, which, as the flat bearing surfaces approach the interior of the mould, the first corner sections of the side walls are glued to the second corner sections of the front walls of the box. The rectangular bottom of the box rests over said flat bearing surfaces when it is inside the mould during the process of assembly. Once the box has been formed, the holding mechanisms retreat to their starting position in order to let the box fall down by the force of gravity or by the pressure of the next box that is going to be assembled.

Above the opposing mechanisms converging ramps inclined towards the inner space of the mould are located, the converging ramps are complemented by curved parts of the assembling parts, where at the start of the insertion of the cardboard sheet when it is pushed from above by the male element, said sheet makes contact with said converging ramps, with the curved parts, and with the spherical lugs of the folding cylinders.

The male element comprises a main body with lateral sides parallel to each other by pairs that converge on chamfered corners corresponding to the corners of the box angled at 45°; said male element also comprises an upper mouth where two opposing tilting supports provided with rollers with angled corners are coupled, so that in an upper position of the male element when said male element is not in use, the tilting supports remain in a horizontal position resting on a part of the mouth of the male element protruding from two of its lateral faces that correspond to the front walls of the box, while when the male element descends in order to form the box, the rollers with angled corners protruding from the two opposing lateral faces make contact and guide the pair of extensions running from the bridges of the box.

The modular structures comprise first carriages and second carriages joined together and coupled to the two guiding rails; and the assembling parts being attached to the first set of carriages.

Said assembling parts are anchored to the first carriages by means of first supports that comprise double angled breaks and by means of second supports made up by three bars arranged in the three spatial directions: a front bar, an intermediate bar, and a rear bar.

The pair of supports: first and second, are linked by means of intermediate pieces attached to the first supports, which have guiding channels where the front bars of the second supports are fitted in, and which secure the intermediate pieces by means of gussets screwed to said intermediate pieces.

The front supports are joined to the first supports of the mould by means of horizontal profiles and by means of straight supports; where the horizontal profiles make up the link between the front supports and the straight supports that are directly attached to the first supports.

The opposing mechanisms comprise rotating axes where folding elements are secured to, so that when said rotating axes rotate from one position to another, the folding elements fold up the bridges and put into position the pairs of extensions of the sides when the box is inside the mould.

The mould also comprises rotating rollers that make contact with the sides walls of the box when the device is descending, so that said rotating rollers aid the descent of the die cut cardboard sheet when it is being pushed by the male element towards the inside of the mould.

During the process of assembling the box, the first corner sections of the side walls are glued to the second corner sections of the front and back walls.

Hereinafter, in order that the present description may more readily be understood, the object of the invention has been detailed in a series of drawings which are an integral part thereof and which are for illustration purposes and without limitation.

### BRIEF DESCRIPTION OF THE DRAWINGS

FIG. 1.—Shows a perspective view of the device for assembling cardboard boxes that is the object of the invention. Each box is produced by inserting a die cut cardboard sheet into a hole of a mould by means of a male element used in order to assemble the box. Four modular structures with a symmetric configuration are highlighted, as well as two opposing structures.

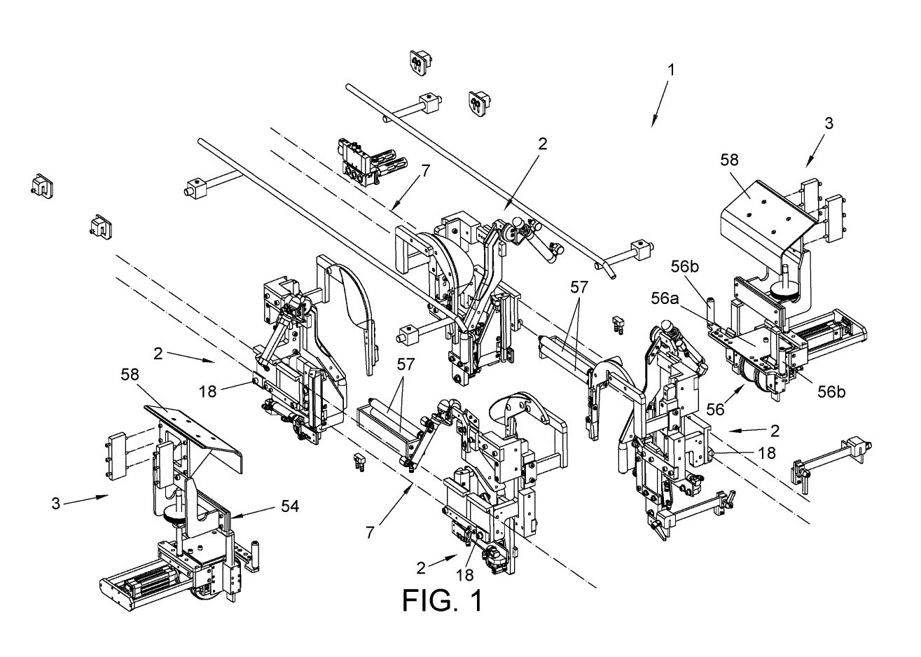

FIG. 2.—Shows an exploded perspective view of a part of the mould where the box is assembled.

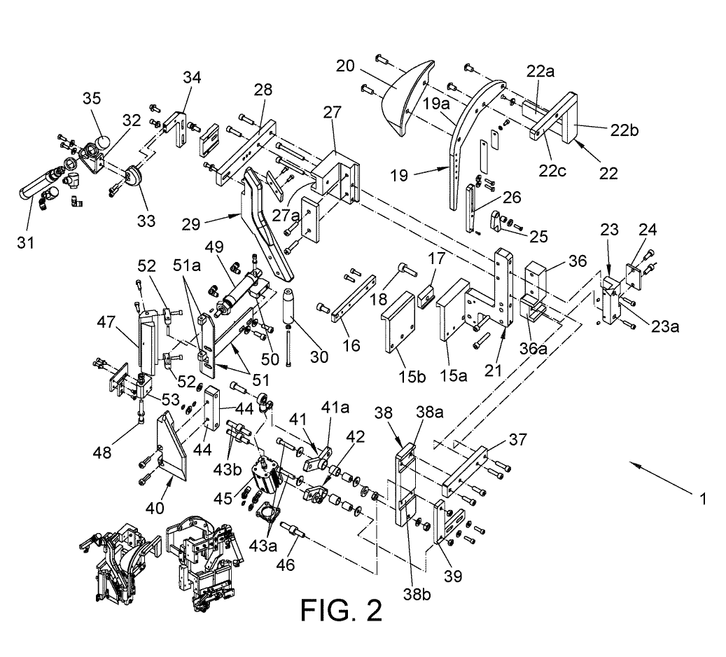

FIG. 3.—Shows an exploded schematic view displaying the mould, the die cut sheet placed on top of the mould, and the male element placed on top of the die cut sheet.

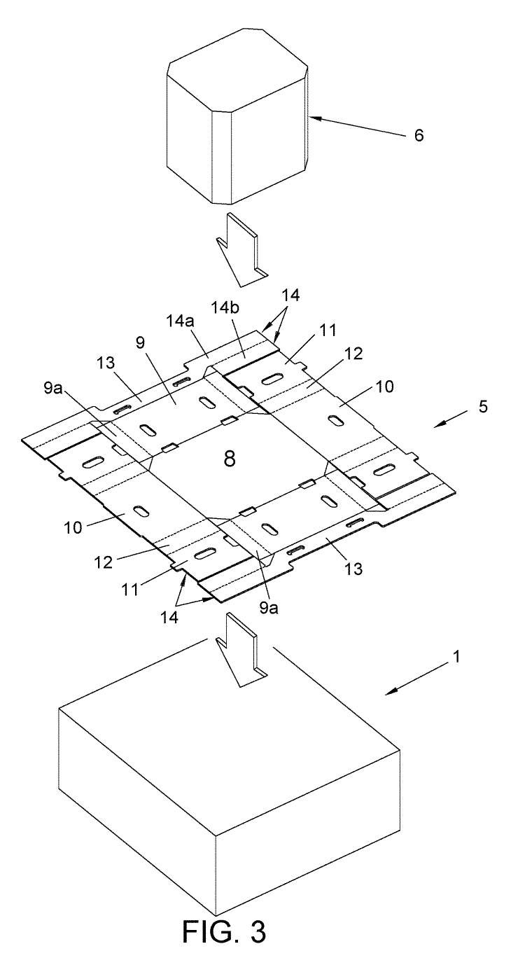

FIG. 4.—Shows a perspective view of one of the four modular structures of the assembling mould that features different mechanisms that take part in forming and assembling each box.

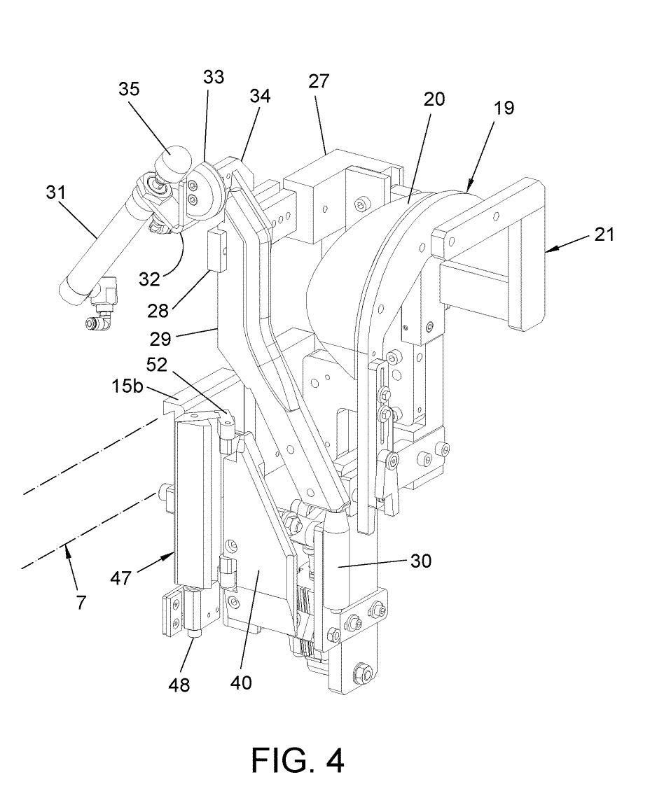

FIG. 5.—Shows a perspective view of the modular structure.

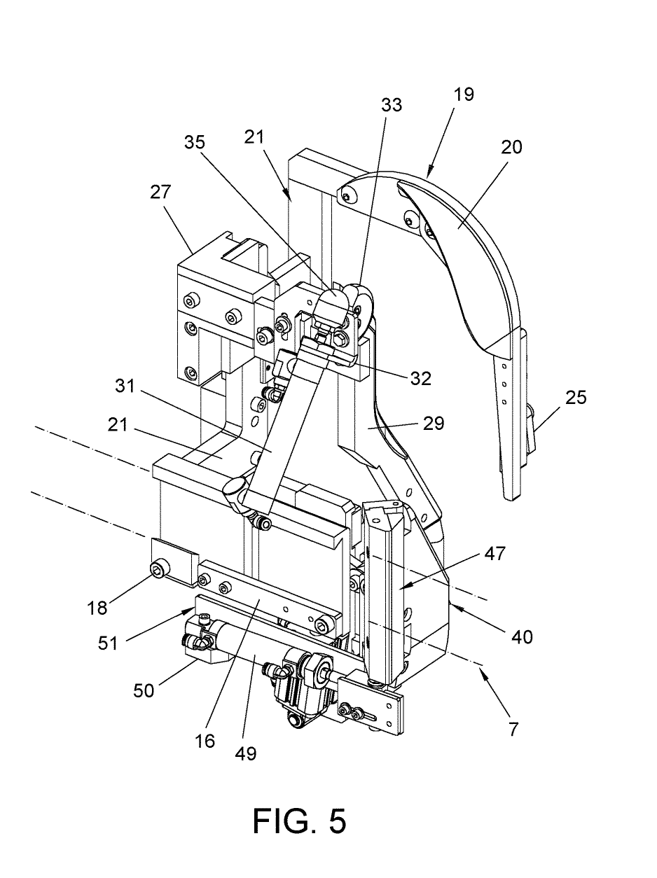

FIG. 6.—Shows a perspective view of the cardboard box during the process of assembly.

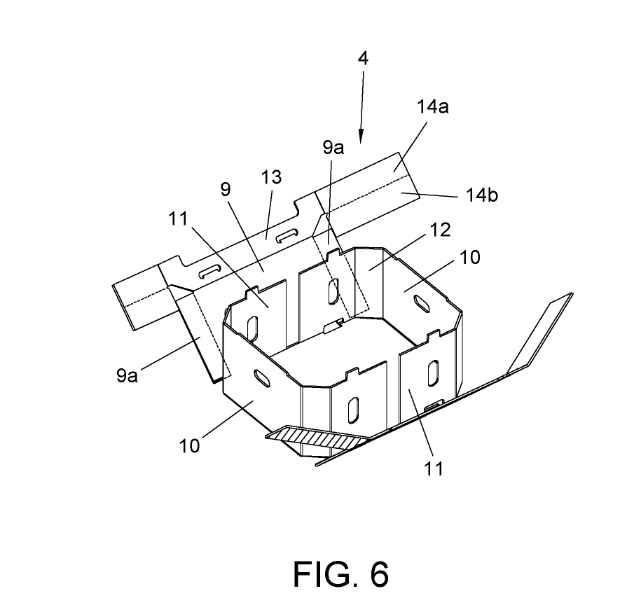

FIG. 7.—Shows a perspective view of one of the roller mechanisms that helps to push out the box out of the mould once it has been assembled.

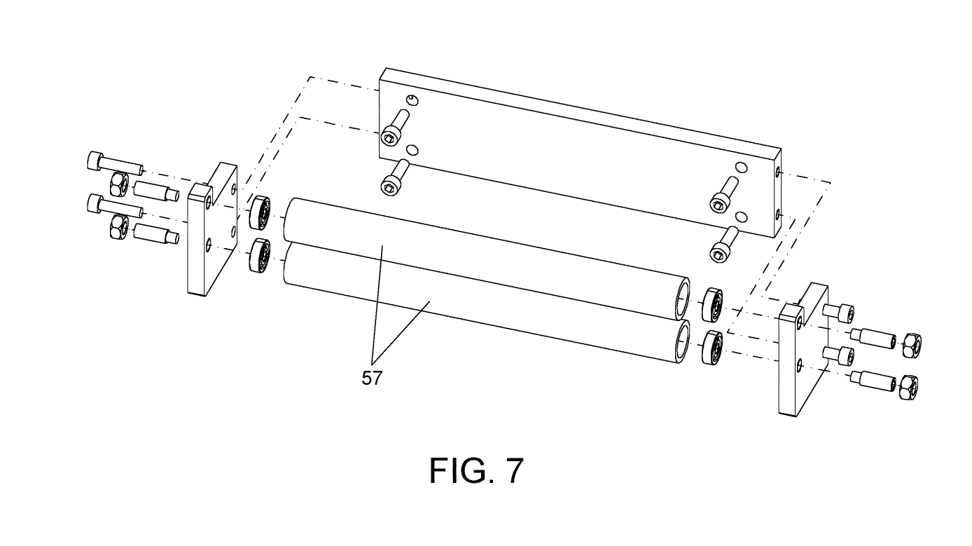

FIG. 8.—Shows a perspective view of the male element in a folded position that is part of the object of the invention.

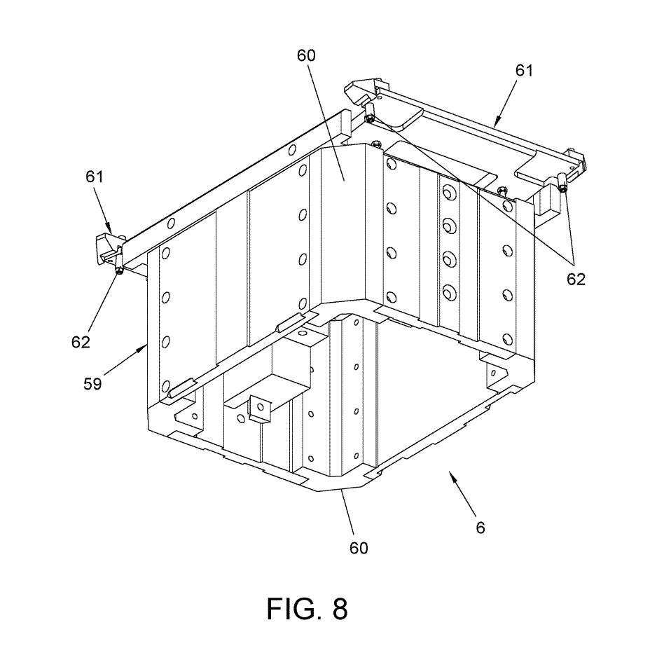

FIG. 9.—Shows a perspective view of the male element when it is unfolded.

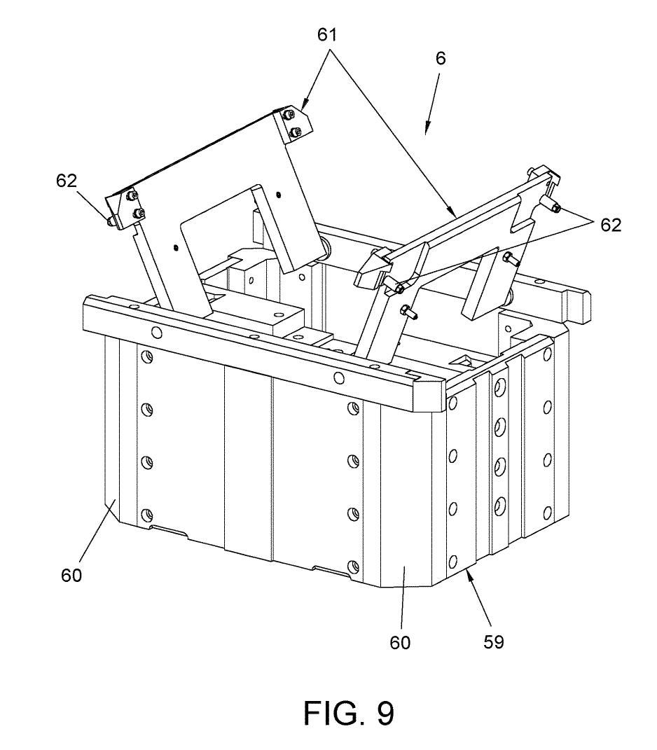

FIG. 10.—Shows perspective view of a series of mechanisms placed in correspondence with each of the opposing structures of the mould.

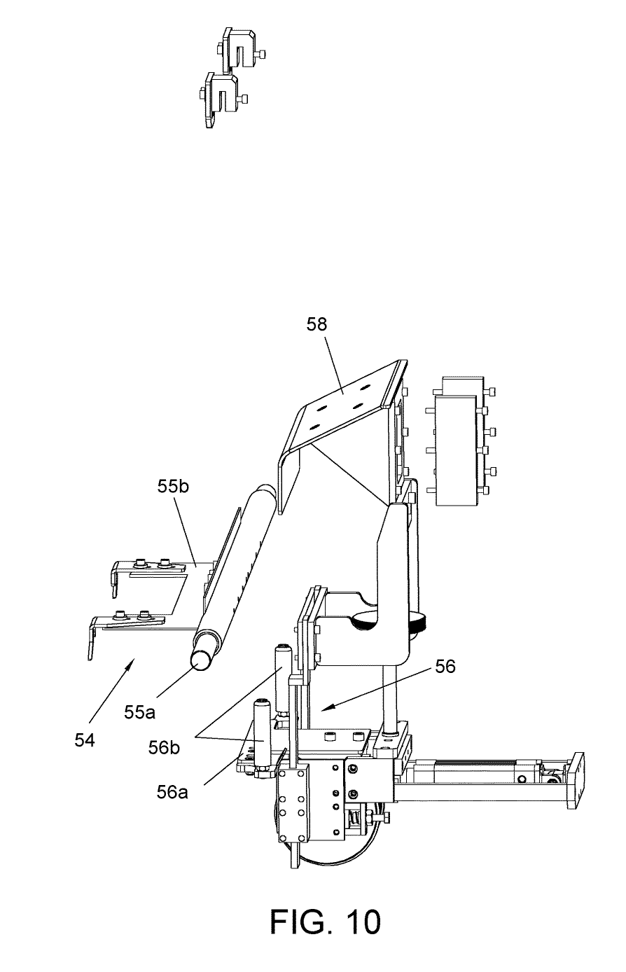

### DESCRIPTION OF AN EMBODIMENT OF THE INVENTION

Considering the numbering adopted in the figures, the device for assembling cardboard boxes 4 comprises firstly a mould 1 and a male element 6 that pushes a die cut sheet 5 against the mouth of a central space of the mould 1 where the box 4 is assembled.

The mould 1 comprises four modular structures 2 with a symmetric configuration and two additional opposing structures 3, each of them supporting different mechanisms that take part in assembling specific boxes 4, so that these four modular structures 2 and the two additional structures 3 define the central space where the die cut cardboard sheet 5 used to assembly each box 4 is inserted into, said sheet 5 is pushed down towards the central space of the mould by means of the male element 6 located above the cardboard sheet 5 and the mould 1, as has been detailed above.

The modular structures 2 are coupled in pairs on two parallel guide frames 7, and the two additional opposing structures 3 are located in correspondence with central areas of said guide frames 7.

Each of the boxes 4 comprise a rectangular bottom 8 with chamfered corners at 45°, two side walls 9 or big lateral walls with first corner sections 9a, two front walls 10 or small lateral walls, a series of flaps 11 that run from the ends of the front walls 10 by means of a series of second corner sections 12, two bridges 13 running from the edges of the sides walls 9; and a pair of opposing extensions 14 that run from the ends of the bridges 13, each of which comprises an outer section 14a that connects with the respective front wall 10 and an inner section 14b that connects with the first corner section 9a, which in turn is connected with the second corner section 12, where the two corner sections 9a, 12 and also the inner section 14b are arranged in correspondence with each of the chamfered corners of the rectangular bottom 8 of the box 4 when it is assembled. A series of end parts of the sides 9 are attached to the flaps 11.

Therefore, the resulting box 4 is a box with vertical corners made up by a structure with corners reinforced at 45°, which is assembled during the assembling process.

Each of the modular structures 2 comprise pairs of carriages: first 15a and second 15b pair of carriages, which are both coupled to their respective guiding rails 7 by means of dovetail guides in order to be able to place each modular structure 2 on the required point all along the guiding rail 7. The two carriages 15a and 15b are connected by means of a crosspiece 16 combined with a retention stop 17 attached to the first carriage 15a by means of an L-shaped bolt 18.

An assembling part 19 with a curved upper part 19a linked to a curved supplement 20 is attached to the first carriage 15a. Said assembling part 19 is anchored to the first carriage 15a by means of a first support 21 that comprises a double angled break and by means of a second support 22 formed by three bars arranged in the three spatial directions: a front bar 22a, an intermediate bar 22b, and a rear bar 22c, so that both supports 21, 22 are linked by means of an intermediate piece 23 attached to the first support 21, the intermediate piece 23 has a guiding channel 23a where the front bar 22a of the second support 22 is placed in, and that secures the intermediate piece 23 by means of a gusset 24 screwed to said intermediate piece 23.

A tilting tab 25 is attached to a lower part of the assembling part 19 by means of an adjustable piece 26 in order to be able to modify the vertical position of said tilting tab 25, which comprises an angled cut.

At the same time, a first L-shaped support 27 is attached to the first support 21, the first L-shaped support 27 has a channel 27a where a horizontal bar 28 is fitted and secured, to which a vertical folding element 29 is attached to, the vertical folding element 29 has two angled breaks that make up a first upper inclined section, a second vertical section, and a third inclined section longer than the first section. A cylinder-shaped vertical extension 30 is attached to the lower end of the vertical folding element 29.

During the process of assembling the box 4, when the die cut sheet 5 is being inserted in the central space of the mould 1, the four vertical folding elements 29 connect with folds that join the sides 9 with the rectangular bottom 8 of the box 4.

Said horizontal bar 28 also supports a folding cylinder 31 attached to said horizontal bar 28 by means of a head 32 that is attached in turn to a folding washer 33 integrally joined to an angled body 34 screwed to the horizontal bar 28. Said folding cylinder 31 comprises a rod with a spherical lug 35 that works on a part of the box 4 during the process of assembly.

The first support 21 is attached to another straight support 36 that has a channel 36a where a horizontal profile 37 is attached, to which another front support 38 is attached to by means of an upper channel 38a; and on a second lower channel 38b of said front support 38 an angled support 39 is secured, where an elevation mechanism to lift and lower an angled stop 40 when the box 4 is being assembled is coupled.

The elevation mechanism comprises two tilting handles: upper 41 and lower 42, that rotate around axes 43a attached to the angled support 39 so that said tilting handles 41, 42 are connected by means of another pair of axes 43b, with a solid piece 44 joined to the angled stop 40. The upper tilting handle 41 comprises a radial extension 41a where the rod of a vertical cylinder 45 rotates, the vertical cylinder 45 rotates on a lower axis 46 attached to the front support.

It also provided a corner stop 47 to make up each of the four vertical areas on the corners of the box 4, where said corners are made up by two double laminar pieces as described above in the description of the configuration of the box 4.

Said corner stop 47 is an element supported by the angled stop 40, and simultaneously said corner stop 47 rotate around a vertical axis 48 by means of a horizontal cylinder 49 connected to an outer piece 50 attached to an end support 51 comprising a horizontal branch where said outer piece 50 is attached, and a vertical branch comprising a pair of hinged parts 51a complimentary with another pair of hinged parts 52 attached to the corner stop 47. The horizontal cylinder 49 comprises a rod connected to a head 53 where the vertical axis 48 is attached to, on which the corner stop 47 rotates.

According to this description, when the box 4 is being assembled, and more precisely when the angled corners of the box 4 are being formed, the vertical cylinder 45 is activated and drags with it the angled stop 40 and also the assembly of the corner stop 47, the outer piece 50 and the outer support 51.

The mould 1 also comprises two opposing mechanisms 54 to fold the bridges 13. In order to achieve this, the opposing mechanisms 54 comprise rotating axes 55a where folding elements 55b are secured to, so that when said rotating axes 55a rotate from one position to another, the folding elements 55b fold up the bridges 13 and put into position the pair of extensions 14 of the sides 9 when the box 4 is inside the mould 1.

Under the opposing mechanisms 54 holding mechanisms 56 comprising flat bearing surfaces 56a and vertical rollers 56b can be found, which as the flat bearing surfaces 56a approach the interior of the mould 1, the first corner sections 9a of the sides 9 are glued to the second corner sections 12 of the front and back walls 10 of the box 4.

The rectangular bottom 8 of the box 4 rests over said flat bearing surfaces 56a when it is inside the mould 1, so that when the box 4 is assembled, it is pushed out by the underside of the device with the aid of a series of rotating rollers 57 that make contact with the sides 9 of the box 4, so that during this process of ejection the flat bearing surfaces 56 are removed in order to let the assembled box 4 pass through.

At the same time, above the opposing mechanisms 54 converging ramps 58 angled towards the inner space of the mould 1 are located, the converging ramps 58 together with the curved parts 19a of the assembling parts 19, aid the process of inserting the cardboard sheet 5 when it is pushed down from above by the male element 6.

The two opposing mechanisms 54, the flat bearing surfaces 56 and the converging ramps 58 are located on the additional structures 3 mentioned above.

The male element 6 comprises a main body 59 that has pairs of lateral sides parallel to each other that converge on chamfered corners 60 that correspond to the corners of the box 4 angled at 45°. At the same time, the male element 6 also comprises an upper mouth where two opposing tilting supports 61 comprising rollers with angled corners 62 are coupled, so that when the male element 6 is inactive, the tilting supports 61 remain in a horizontal position resting over a part of the mouth of the male element 6 protruding from two of its lateral faces that correspond to the front walls 10 of the respective box 4, while when the male element descends in order to form the box 4, the rollers with angled corners 62 protruding from the two opposing lateral faces make contact and guide the pair of extensions 14 running from the bridges 13 of the box 4.

Therefore, the tilting supports 61 of the male element 6 comprise rollers with angled corners 62, so that when said male element 6 pushes the cardboard sheet 5 towards the inside of the mould 1, said rollers with angled corners 62 make contact and guide the pair of extensions 14 running from the bridges 13 in order to insert them into existing holes designed for that purpose, that are located between the vertical folding elements 29 and the curved supplements 20 joined to the assembling pieces 19.

1. Device for assembling cardboard boxes, comprising a mould (1) and a male element (6) that pushes a die cut sheet (5) towards a central space of the mould (1) where a box (4) with a rectangular bottom (8) with chamfered corners at 45° is assembled applying previously an adhesive material on the sheet; said mould (1) comprises four modular structures (2) and two additional opposing structures (3), each of them supporting different mechanisms that take part in assembling the box (4), where said four modular structures (2) and the two additional structures (3) define the central space where the die cut cardboard sheet (5) used to assembly each box (4) is inserted into; the modular structures (2) are coupled by pairs on two parallel guide frames (7); the two additional opposing structures (3) are located in correspondence with the two opposing walls where said guide frames (7) are located; the box (4) comprising two side walls (9) and two front walls (10) that converge on corners angled at 45°, made up first by first corner sections (9a) that run from the ends of the side walls (9), by second corner sections (12) that run from the ends of the front walls (10), and by inner sections (14b) that are part of extensions (14) that run from the ends of the two bridges (13) running from the edges of the side walls (9); and said extensions (14) of the bridges (13) also comprise outer sections (14a) that lean against the front walls (10);
characterized in that the modular structures (2) comprise at least the following:
vertical folding elements (29) facing each other by pairs, which have two angled breaks that make up first upper inclined sections, second vertical sections, and third inclined sections longer than the first sections; where cylinder-shaped vertical extensions (30) are attached to the lower ends of the vertical folding elements (29), and said vertical folding elements (29) are secured to transverse bars (28);
folding cylinders (31) attached to said transverse bars (28) by means of heads (32) attached in turn to folding washers (33) integrally joined to angled bodies (34) screwed to the transverse bars (28); where said folding cylinders (31) comprise rods with spherical lugs (35) that work on some of the parts of the die cut sheets (5) during the descent of the male element (6);
elevation mechanisms to lift and lower angled stops (40) during the process of assembling the box (4); where said angled stops (40) make contact with the parts of the box (4) that correspond to the ends of the front walls (10);
corner stops (47) that press against the corners of the box during the assembly, where said corner stops (47) rotate around vertical axes (48) and where said stops (47) are supported by the angled stops (40);
it is also characterized in that it comprises opposing mechanisms (54) to make up the bridges (13) by folding them, and tabs (25), with angled cuts, attached to assembling parts (19) of the modular structures (2) by means of regulating elements (26) that control the vertical position of said tabs (25).

2. Device for assembling cardboard boxes, according to claim 1, characterized in that the elevation mechanism comprises pairs of tilting handles: upper (41) and lower (42), that rotate around axes (43a) attached to angled supports (39), where said tilting handles (41, 42) are articulately connected by means of other pairs of axes (43b), with solid pieces (44) integrally joined to the angled stops (40).

3. Device for assembling cardboard boxes, according to claim 2, characterized in that the upper tilting handles (41) comprise radial extensions (41a) where rods of vertical cylinders (45) rotate around, the vertical cylinders (45) rotate around lower axes (46) attached to front supports (38) joined to the angled supports (39).

4. Device for assembling cardboard boxes, according to claim 1, characterized in that the corner stops (47) rotate around the vertical axes (48) by means horizontal cylinders (49), which are articulately connected to outer pieces (50) attached to end supports (51) comprising horizontal branches where said outer pieces (50) are attached, and vertical branches comprising pairs of hinged parts (51a) supplementary with other pairs of hinged parts (52) attached to the corner stops (47).

5. Device for assembling cardboard boxes, according to claim 4, characterized in that the horizontal cylinders (49) comprise rods connected to end heads (53) where the vertical axes (48) on which the corner stops (47) rotate are attached.

6. Device for assembling cardboard boxes, according to claim 1, characterized in that under the opposing mechanisms (54) holding mechanisms (56) are located, the holding mechanisms (56) comprising flat bearing surfaces (56a) where the rectangular bottom (8) of the box (4) and vertical rollers (56b) rest on, which, as the flat bearing surfaces (56a) approach the interior of the mould (1), the first corner sections (9a) of the sides (9) are glued to the second corner sections (12) of the front and back walls (10) of the box (4).

7. Device for assembling cardboard boxes, according to claim 1, characterized in that above the opposing mechanisms (54) converging ramps (58) inclined towards the inner space of the mould (1) are located, the converging ramps (58) are complemented by curved parts (19a) of the assembling parts (19), where at the start of the insertion of the cardboard sheet (5) when it is pushed from above by the male element (6), said sheet (5) makes contact with said converging ramps (58), with the curved parts (19a), and with the spherical lugs (35) of the folding cylinders (31).

8. Device for assembling cardboard boxes, according to claim 1, characterized in that the male element (6) comprises:
a main body (59) with lateral sides parallel to each other by pairs that converge on chamfered corners (60) corresponding to the corners of the box (4) angled at 45°;
an upper mouth where two opposing tilting supports (61) comprising rollers with angled corners (62) are coupled, so that in an upper position of the male element (6) when said male element (6) is inactive, the tilting supports (61) remain in a horizontal position resting on a part of the mouth of the male element (6) protruding from two of its lateral faces corresponding to the front walls (10) of the respective box (4), while when the male element (6) descends in order to form the box (4), the rollers with angled corners (62) protruding from the two opposing lateral faces make contact and guide the pair of extensions (14) running from the bridges (13) of the box (4).

9. Device for assembling cardboard boxes, according to claim 1, characterized in that:
the modular structures (2) comprise first carriages (15a) and second carriages (15b) joined together and coupled to the two guiding rails (7); the assembling parts (19) being attached to the first carriages (15a);
said assembling parts (19) are anchored to the first carriages (15a) by means of first supports (21) that comprise double angled breaks and by means of second supports (22) made up by three bars arranged in the three spatial directions: a front bar (22a), an intermediate bar (22b), and a rear bar (22c);
the pairs of supports (21, 22) are linked by means of intermediate pieces (23) attached to the first supports (21), the intermediate pieces (23) have guiding channels (23a) where the front bars (22a) of the second supports (22) are fitted in, which secure the intermediate pieces (23) by means of gussets (24) screwed to said intermediate pieces (23).

10. Device for assembling cardboard boxes, according to claim 3, characterized in that:
the modular structures (2) comprise first carriages (15a) and second carriages (15b) joined together and coupled to the two guiding rails (7); the assembling parts (19) being attached to the first carriages (15a);
said assembling parts (19) are anchored to the first carriages (15a) by means of first supports (21) that comprise double angled breaks and by means of second supports (22) made up by three bars arranged in the three spatial directions: a front bar (22a), an intermediate bar (22b), and a rear bar (22c);
the pairs of supports (21, 22) are linked by means of intermediate pieces (23) attached to the first supports (21), the intermediate pieces (23) have guiding channels (23a) where the front bars (22a) of the second supports (22) are fitted in, which secure the intermediate pieces (23) by means of gussets (24) screwed to said intermediate pieces (23); and
the front supports (38) are joined to the first supports (21) of the mould (1) by means of horizontal profiles (37) and by means of straight supports (36), where the horizontal profiles (37) make up the link between the front supports (38) and the straight supports (36) that are attached directly to the first supports (21).

11. Device for assembling cardboard boxes, according to claim 1, characterized in that the opposing mechanisms (54) comprise rotating axes (55a) where folding elements (55b) are secured to, so that when said rotating axes (55a) rotate from one position to another, the folding elements (55b) fold up the bridges (13) and put into position the pairs of extensions (14) of the side walls (9) when the box (4) is inside the mould (1).

12. Device for assembling cardboard boxes, according to claim 1, characterized in that the mould (1) also comprises rotating rollers (57) that make contact with the side walls (9) of the box (4) when the device is descending.
